(19) United States
(12) Patent Application Publication
(10) Pub. No.: US 2018/0291997 A1
(43) Pub. Date: Oct. 11, 2018

(54) GEAR TOOTH GEOMETRY FOR CROWD GEAR ASSEMBLY ON ROPE SHOVEL

(71) Applicant: Caterpillar Global Mining LLC, Oak Creek, WI (US)

(72) Inventor: Timothy Alan VAIL, Caledonia, WI (US)

(73) Assignee: Caterpillar Global Mining LLC, Oak Creek, WI (US)

(21) Appl. No.: 15/483,381

(22) Filed: Apr. 10, 2017

(51) Int. Cl. F16H 55/08; F16H 55/17

(52) U.S. Cl. CPC F16H 55/0886; E02F 3/308; F16H 55/17

(57) ABSTRACT

A tooth of a pinion has a first flank extending across a face width of the tooth in an axial direction substantially parallel to a central axis of the pinion from a first axial end of the tooth to a second axial end of the tooth. The first flank has a first, convex crown profile shaped as an arc of a first circle with a first radius, and a first center of arc radius of the first flank is a point on the first flank located on a line perpendicular to the central axis of the pinion and passing through the center of the first circle. A second opposite and opposing flank of the tooth has a second, convex crown profile shaped as an arc of a second circle with a second radius, wherein a second center of arc radius of the second flank is a point on the second flank located on a line perpendicular to the central axis of the pinion and passing through the center of the second circle. The first center of arc radius of the first flank is located at approximately the midpoint of the face width of the tooth, and the second center of arc radius of the second flank is offset in the axial direction toward one of the first or second axial ends of the tooth relative to the first center of arc radius by a distance that is approximately 30-40% of the face width of the tooth.

### TECHNICAL FIELD

The present disclosure is directed to a gear tooth geometry and, more particularly, to gear tooth geometry for a crowd gear assembly on a rope shovel.

### BACKGROUND

Power shovels and draglines are in a category of machines that are used to remove large amounts of overburden and ore during a mining operation. The power shovels typically include a boom, a dipper handle pivotally and slidably connected at a mid-point of the boom, and a shovel bucket (also known as a dipper) connected to one end of the dipper handle. Crowd ropes are wound and unwound from a crowd drum in order to move the dipper handle forward and rearward, and hoist cables are wound and unwound from a hoist drum in order to raise and lower the dipper. The hoist cables pass over a pair of sheaves (pulleys)—generally referred to as boom point sheaves, at a distal end of the boom to an end of the dipper handle supporting the dipper. The crowd ropes are reeled in or spooled out from the crowd drum by electric, hydraulic, and/or mechanical motors connected to the crowd drum to selectively move the dipper handle and dipper forward, thereby “crowding” the dipper into a bank of material, and retract the dipper away from the bank of material after it is loaded with material. The hoist cables are reeled in over the hoist drum in order to raise the dipper through the bank of material and then spooled out from the hoist drum to lower the dipper as it is retracted by the crowd rope and crowd drum from the bank of material.

A crowd drum gearbox assembly includes the crowd drum around which the crowd ropes are unwound and wound in order to cause the dipper assembly to move forward or “crowd” into the bank of material and retract from the bank of material. A typical crowd drum gearbox includes three reduction gear sets, with each of the reduction gear sets including a larger reduction gear engaged with a smaller reduction pinion. A third reduction gear of a third reduction gear set in the crowd drum gearbox forms the crowd drum gear and is integrated with or connected to the crowd drum. The crowd ropes are anchored at one end to the crowd drum, and wrap around the crowd drum on opposite sides of the crowd drum gear, generally laying in a series of adjacent circumferential grooves extending around the outer diameter of the crowd drum. During every dig cycle at a mine site or other location, the gears and pinions in the crowd drum gearbox are repeatedly driven in a first direction during each crowd mode of operation, and then driven in the opposite direction during a retract mode of operation. The loads and resulting deflections affecting the gears and pinions may be significantly different during crowd mode than during retract mode. This asymmetrical loading can cause deflection of the intermeshing gears and associated gear teeth, resulting in poor contact between some of the gear teeth and premature failing of the gearing in the crowd drum gearbox assembly.

An example of an effort to reduce wear on gear teeth that experience different loading depending on the direction the gear is driven is shown in U.S. Pat. No. 9,145,964 to Potts et al., issued Sep. 29, 2015 (“Potts”). A bevel gear tooth of Potts includes a load flank of the tooth being provided with an excess amount of material as compared to a non-working flank of the tooth. The gear tooth of Potts is asymmetrical relative to an axis running through a tooth-tip bisecting point of a line transverse to the tooth-tip such that added material is provided along the entire face width of the load flank of the tooth. The resulting enlarged radii of curvature of the load flank of the gear tooth results in a reduction of flank contact pressure. While Potts purports to improve the load rating of a bevel gear, the disclosure does not provide a solution for poor contact between intermeshing gear teeth of gears that are deflected and misaligned relative to each other as a result of asymmetric loading occurring when the gears are repeatedly driven in one direction and then in an opposite direction.

The gear tooth geometry according to the present disclosure for gear teeth of intermeshing gears in a gearbox that experiences asymmetric loading and deflections of the gears solves one or more of the problems set forth above and/or other problems in the art.

### SUMMARY

In one aspect, the present disclosure is directed to a tooth of a pinion. The tooth includes a first flank of a first face of the tooth extending across a face width of the tooth in an axial direction substantially parallel to a central axis of the pinion from a first edge of the first face at a first axial end of the tooth to a second edge of the first face at a second axial end of the tooth. The first flank includes a first, convex crown profile shaped as an arc of a first circle with a first radius, wherein a first center of arc radius of the first flank is a point on the first flank located on a line perpendicular to the central axis of the pinion and passing through the center of the first circle. A second flank of an opposite and opposing second face of the tooth extends across the face width of the tooth in the axial direction from a first edge of the second face at the first axial end of the tooth to a second edge of the second face at a second axial end of the tooth. The second flank includes a second, convex crown profile shaped as an arc of a second circle with a second radius, wherein a second center of arc radius of the second flank is a point on the second flank located on a line perpendicular to the central axis of the pinion and passing through the center of the second circle. The first center of arc radius of the first flank is located on the first face of the tooth at an axial distance from at least one of the first and second axial ends of the tooth that is approximately 50%±10% of the face width of the tooth. The second center of arc radius of the second flank on the second face of the tooth is offset in the axial direction toward one of the first or second axial ends of the tooth relative to the first center of arc radius by a distance that is approximately 30-40% of the face width of the tooth.

In another aspect, the present disclosure is directed to a pinion for a crowd gear assembly on a rope shovel, wherein the crowd gear assembly is subjected to at least one of asymmetric loading or asymmetric deflection when the pinion is driven in a first crowd direction as compared to when the pinion is driven in an opposite retract direction. The pinion includes a tooth, and the tooth includes a retract flank on a first face of the tooth extending across a face width of the tooth in an axial direction substantially parallel to a central axis of the pinion from a first edge of the retract flank at a first axial end of the tooth to a second edge of the retract flank at a second axial end of the tooth. The retract flank includes a first, convex crown profile shaped as an arc of a first circle with a first radius, wherein a first center of arc radius of the retract flank is a point on the retract flank located on a line perpendicular to the central axis of the pinion and passing through the center of the first circle. A crowd flank on an opposite and opposing second face of the tooth extends across the face width of the tooth in the axial direction from a first edge of the crowd flank at the first axial end of the tooth to a second edge of the crowd flank at the second axial end of the tooth. The crowd flank includes a second, convex crown profile shaped as an arc of a second circle with a second radius, wherein a second center of arc radius of the crowd flank is a point on the crowd flank located on a line perpendicular to the central axis of the pinion and passing through the center of the second circle. The first center of arc radius of the retract flank is located on the first face of the tooth at an axial distance from at least one of the first and second axial ends of the tooth that is approximately 50%±10% of the face width of the tooth. The second center of arc radius of the crowd flank on the second face of the tooth is offset in the axial direction toward one of the first or second axial ends of the tooth relative to the first center of arc radius by a distance that is approximately 30-40% of the face width of the tooth.

In yet another aspect, the present disclosure is directed to a method of manufacturing a gear. The method includes forming a first flank on a first face of a tooth of the gear extending across a face width of the tooth in an axial direction substantially parallel to a central axis of the gear from a first edge of the first flank at a first axial end of the tooth to a second edge of the first flank at a second axial end of the tooth. The first flank includes a first, convex crown profile shaped as an arc of a first circle with a first radius, wherein a first center of arc radius of the first flank is a point on the first flank located on a line perpendicular to the central axis of the gear and passing through the center of the first circle. The method further includes forming a second flank on an opposite and opposing second face of the tooth extending across the face width of the tooth in the axial direction from a first edge of the second flank at the first axial end of the tooth to a second edge of the second flank at the second axial end of the tooth. The second flank includes a second, convex crown profile shaped as an arc of a second circle with a second radius, wherein a second center of arc radius of the second flank is a point on the second flank located on a line perpendicular to the central axis of the gear and passing through the center of the second circle. The first center of arc radius of the first flank is located on the first face of the tooth at an axial distance from at least one of the first and second axial ends of the tooth that is approximately 50%±10% of the face width of the tooth. The second center of arc radius of the second flank on the second face of the tooth is offset in the axial direction toward one of the first or second axial ends of the tooth relative to the first center of arc radius by a distance that is approximately 30-40% of the face width of the tooth.

### BRIEF DESCRIPTION OF THE DRAWINGS

FIG. 1 shows an exemplary rope shovel with a rope crowd mechanism including a crowd drum and crowd gearbox with reduction gears and reduction pinions having teeth that may include a tooth geometry according to this disclosure;

FIG. 2 is a partially cut-away isometric view of an exemplary crowd gear case including multiple intermeshing reduction gears and reduction pinions with teeth that may include a tooth geometry according to this disclosure;

FIG. 3 is an isometric illustration of the exemplary reduction gearsets from the gear case of FIG. 2;

FIG. 4 is a view looking radially inward at an exemplary pinion tooth in the direction of arrows 4-4 in FIG. 5; and

FIG. 5 is an isometric illustration of an exemplary reduction pinion on an exemplary pinion shaft from the gear case of FIG. 2.

### DETAILED DESCRIPTION

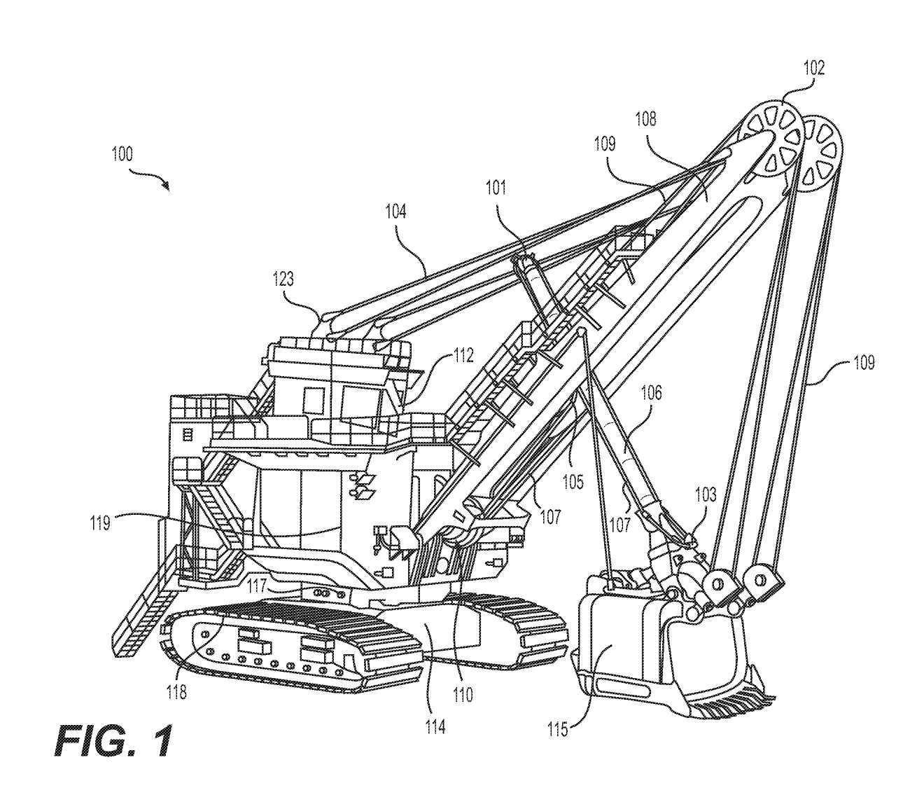

FIG. 1 illustrates an exemplary rope shovel 100 with a rope crowd mechanism including a crowd drum and crowd reduction gear sets housed within a crowd gear case 110. The exemplary crowd reduction gear sets may include reduction gears and reduction pinions having teeth that may include a tooth geometry according to this disclosure. While a distinction may be made in certain disclosed embodiments and implementations of this disclosure between a reduction “gear” and a reduction “pinion”, one of ordinary skill in the art will recognize that the disclosed embodiments of the geometries of the flanks on opposing faces of the teeth of a pinion may be equally applicable to the flanks on opposing faces of the teeth on any gear.

The rope shovel 100 may include a crawler frame track assembly 118, a car body 114 connected to the crawler frame track assembly 118 in between the tracks, a revolving frame 117 mounted on the car body 114, and a machinery house 119 mounted on the revolving frame 117. An operator cab may be provided at the top end of the machinery house 119. An A-frame 112 may extend up through the machinery house 119 from the revolving frame 117. In FIG. 1, a portion of one of two A-frame structures can be seen adjacent the operator cab at the top end of the machinery house 119. Boom suspension strands 104 may be connected between anchors 123 at the top of the A-Frame 112 and a distal end of a boom 108. A proximal end of the boom 108 may be connected to the machinery house 119. A dipper handle 106 may be slidably and pivotally mounted to the boom 108 by a saddle block mechanism. The saddle block mechanism is generally a casting slidably supported in a longitudinal opening extending along the boom 108, and the dipper handle 106 is pivotally mounted to the saddle block mechanism on a shipper shaft extending transversely to dipper handle 106 and the boom 108.

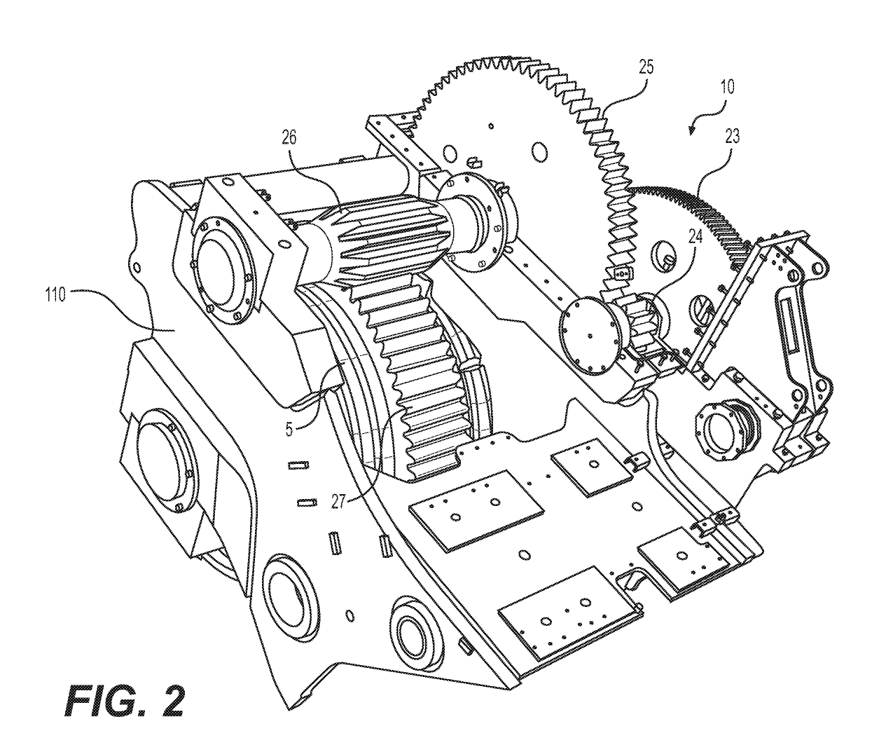

As shown in FIGS. 1 and 2, the crowd gear case 110 may be mounted to the machinery house 119 at the proximal end of the boom 108, with a portion of the crowd gear case 110 contained within the machinery house 119, and a portion protruding from the machinery house 119 and, as shown in FIG. 1, visible at the proximal end of the boom 108. A crowd rope 107 is wrapped around the crowd drum 5 rotatably mounted within the crowd gear case 110, and extends out from the crowd gear case 110, up along the boom 108, and around a set of sheaves (pulley mechanisms) 105 supported on the shipper shaft and located on opposite sides of the saddle block mechanism supporting the dipper handle 106. The crowd rope 107 then passes from the sheaves 105 on the saddle block, along the dipper handle 106 and around a protruding horn (pulley mechanism) 103 on the distal end of the dipper handle 106. The crowd rope 107 passes from the pulley mechanism 103 adjacent the dipper 115 at the distal end of the dipper handle 106, back up along the dipper handle 106 and around a crowd rope take-up mechanism (pulley mechanism) 101 at the proximal end of the dipper handle 106. The crowd rope continues back along the dipper handle 106 from the crowd rope take-up mechanism 101, around the sheaves 105 on opposite sides of the saddle block, and back down to the crowd drum 5 within the crowd gear case 110. Rotation of the crowd drum 5 in one direction spools out the crowd rope 107 from the crowd drum 5 and exerts a force on the proximal end of the dipper handle 106 to cause the dipper handle 106 to extend outwardly from the boom 108 and away from the machinery house 119. This movement extending the dipper handle 106 and attached dipper 115 away from the boom 108 is referred to as “crowding” the dipper 115 since it results in moving the dipper into a bank of material being excavated by the rope shovel. At the same time as the crowd drum 5 is rotated to spool out crowd rope 107 and cause the dipper handle 106 and attached dipper 115 to “crowd” into a bank of material, another gear assembly within the machinery house 119 causes a hoist drum (not shown) to rotate and reel in a hoist cable 109 that extends up from the machinery house 119 along the boom 108, around pulley mechanisms 102 at the distal end of the boom 108 (generally referred to as boom point sheaves), and down to the dipper 115. The reeling in of the hoist cable 109 simultaneously with the spooling out of the crowd rope 107 causes the dipper 115 to be moved into and up through the bank of material to acquire a load of the material in the dipper 115. A reversal of the direction of rotation of the crowd drum 5 to reel in the crowd rope 107 will then cause the dipper handle 106 and dipper 115 to pull back from the bank of material so that the rope shovel can rotate about the revolving frame 117 to move the dipper 115 over to a second location for dumping into a dump truck or other disposal of the material in the dipper 115.

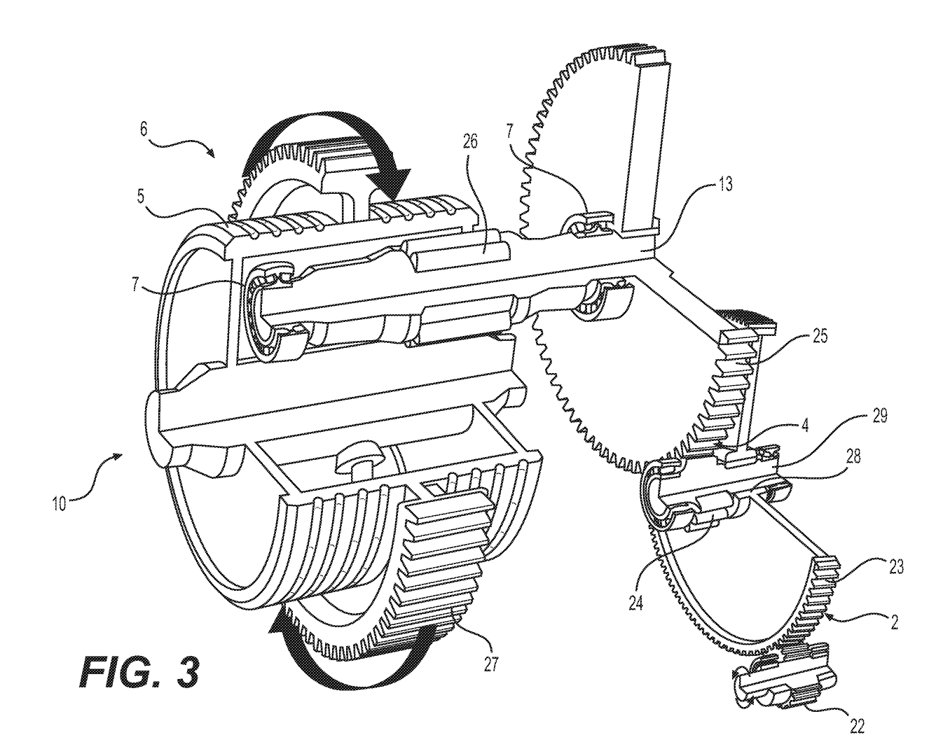

As shown in FIGS. 2 and 3, the crowd gear case 110 may contain multiple sets of reduction gears and reduction pinions that result in the rotation of the crowd drum 5 in one direction during a crowd cycle, and in an opposite direction during a retract cycle. Various power sources such as a hydraulic motor, or an electric motor (not shown) may be connected to the reduction gear sets within the crowd gear case 110 to rotate the crowd drum 5. In an exemplary crowd gear assembly according to this disclosure, the crowd gear case 110 and one or more reduction gears and reduction pinions of the crowd gear assembly may be subjected to significantly different loading and/or deflections depending on whether the crowd gear assembly is rotating in a crowd direction or in a retract direction. As a result, every dig cycle can subject the intermeshing teeth of the reduction gear sets within the crowd gear case to deflections relative to each other that may cause the intermeshing teeth to skew away from parallel alignment with each other, causing poor contact between the teeth, and premature failure of the gearing.

As shown in FIG. 3, an exemplary embodiment of a crowd gear assembly 10 may include a first reduction gear set 2, with a first reduction pinion 22 engaged with a first reduction gear 23, a second reduction gear set 4, with a second reduction pinion 24 engaged with a second reduction gear 25, and a third reduction gear set 6, with a third reduction pinion 26 engaged with a third reduction gear 27. The third reduction gear 27 may be connected to or formed integrally with the crowd drum 5. The crowd drum 5 may include multiple circumferential grooves configured to guide the crowd rope 107 as the crowd drum 5 is rotated in the crowd direction to spool out the crowd rope 107 from the crowd drum, and in the opposite retract direction to reel in the crowd rope 107 onto the crowd drum. The loads exerted on the crowd rope 107 during each dig cycle are transferred to the crowd drum 5, and then to the third reduction gear 27 and third reduction pinion 26. These loads can cause deflection of the gear shaft 13 connecting the third reduction pinion 26 to the second reduction gear 25, and this deflection can then cause the teeth on the second reduction gear 25 to move out of parallel alignment with the intermeshing teeth on the second reduction pinion 24. In some exemplary implementations of the crowd gear assembly, the amount of deflection of the gears during a crowd cycle can be significantly different than during a retract cycle. As a result, the deviation from parallel alignment of the intermeshing teeth in the second reduction gear set 4 can result in poor contact between the teeth and premature failure of the gears. Although an exemplary embodiment of a gear assembly according to this disclosure is a crowd gear assembly used to drive a crowd drum on a rope shovel, alternative embodiments may find application in a variety of other gear assemblies used in a number of different applications where a gear is subjected to significantly different deflections when driven in one direction than when driven in an opposite direction.

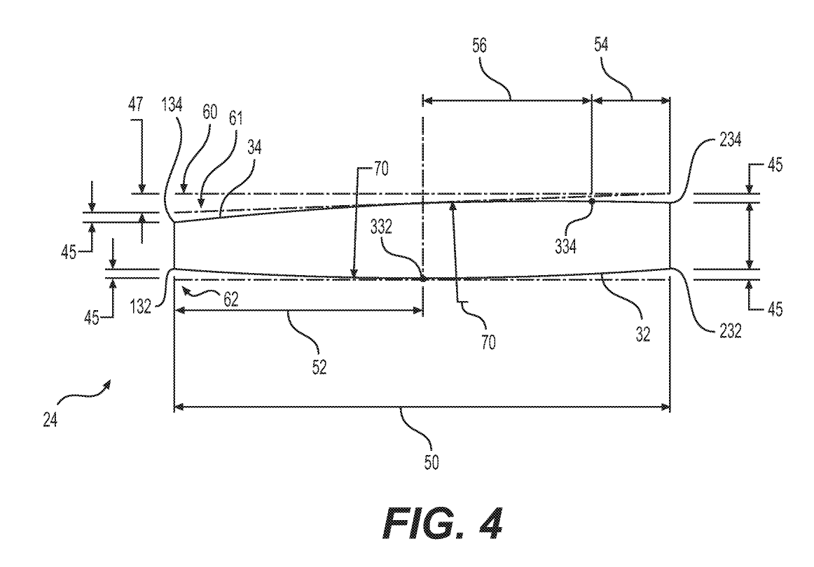

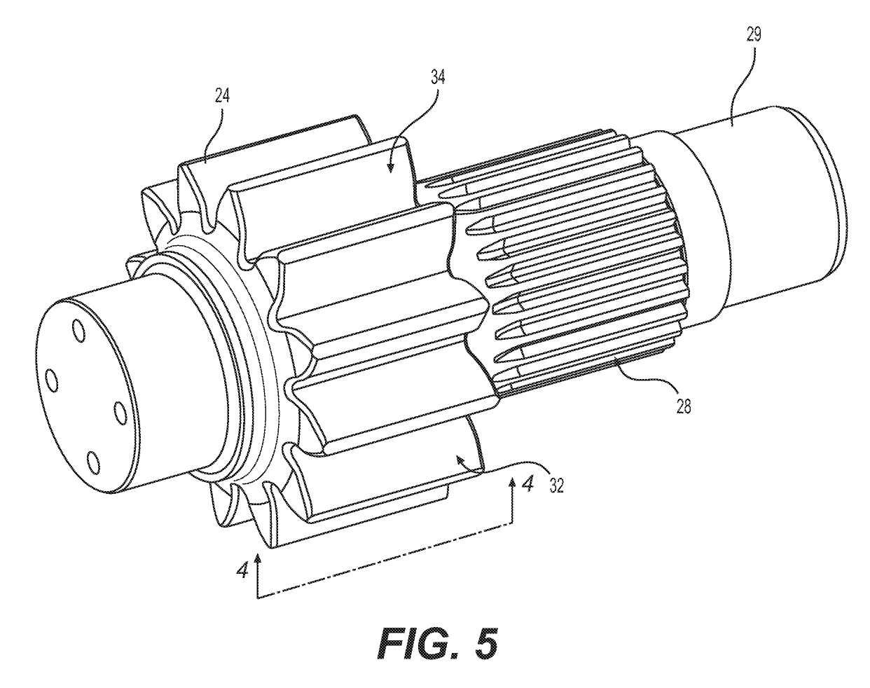

FIG. 4 illustrates a radial plan view of an exemplary pinion tooth according to this disclosure. The tooth may be provided with different geometries on opposing flanks in order to compensate for the asymmetric loading and/or deflection of the gears as the crowd drum is alternately rotated in a crowd direction and in a retract direction during each dig cycle. The tooth shown in FIG. 4 is a tooth of the second reduction pinion 24 from the second reduction gear set 4, as viewed in the direction of the arrows 4-4 in FIG. 5. As discussed above with regard to alternative implementations of the disclosed gear assemblies, the disclosed exemplary tooth geometries may also be used on other gears and in other applications than the specific exemplary disclosed applications. The tooth includes a retract flank 32 on a first face of the tooth extending across a face width 50 of the tooth defined in an axial direction that is substantially parallel to a central axis of the pinion 24. The retract flank 32 extends from a first edge 232 of the retract flank 32 at a first axial end of the tooth to a second edge 132 of the retract flank 32 at a second axial end of the tooth. As shown in the exemplary embodiment of FIG. 4, the retract flank may include a first, convex crown profile shaped as an arc of a first circle with a first radius 70. A first center of arc radius 332 of the retract flank 32 is a point on the retract flank 32 located on a line perpendicular to the central axis of the pinion 24 and passing through the center of the first circle. In the exemplary embodiment as illustrated in FIG. 4, the center of this first circle would be located at a point vertically above the center of arc radius 332 on the retract flank 32 at a distance from the center of arc radius 332 equal to the radius 70 of the first circle. The radius of an arc that lies on a circle, such as the arc of the retract flank 32, has the same radius as the circle defining the arc. In this disclosure, the “center of arc radius” for each of the crowd and retract flanks of the tooth on a pinion is defined as a point on each respective flank that is in line in a direction perpendicular to the central axis of the pinion with the center of the circle defining the arc of the flank.

A crowd flank 34 on an opposite and opposing second face of the tooth extends across the face width 50 of the tooth in the axial direction from a first edge 234 of the crowd flank 34 at the first axial end of the tooth to a second edge 134 of the crowd flank 34 at the second axial end of the tooth. The crowd flank 34 may include a second, convex crown profile shaped as an arc of a second circle with a second radius 70. In the exemplary embodiment of a tooth shown in FIG. 4, the second radius 70 is substantially equal to the first radius 70, within normal machining tolerances. A second center of arc radius 334 of the crowd flank 34 is a point on the crowd flank 34 located on a line perpendicular to the central axis of the pinion and passing through the center of the second circle. In the exemplary embodiment shown in FIG. 4, the center of this second circle would be located at a point directly below the center of arc radius 334 on the crowd flank 34 at a distance from the center of arc radius 334 equal to the radius 70 of the second circle. As discussed above, the center of arc radius 334 for the crowd flank 34 of the tooth on the pinion 24 is defined as the point on the crowd flank 34 that is in line in a direction perpendicular to the central axis of the pinion 24 with the center of the second circle defining the arc of the crowd flank 34.

The first center of arc radius 332 of the retract flank 32 is located on the first face of the tooth at an axial distance from at least one of the first and second axial ends of the tooth that is approximately 50%±10% of the face width 50 of the tooth. The second center of arc radius 334 of the crowd flank 34 on the second face of the tooth is offset in the axial direction toward one of the first or second axial ends of the tooth relative to the first center of arc radius 332 by a distance 56 that is approximately 30%-40% of the face width 50 of the tooth. As shown in the exemplary embodiment of FIG. 4, the axial offset 56 of the center of arc radius 334 of the crowd flank 34 is toward the first axial end of the tooth, and the center of arc radius 334 is located axially inward from the first axial end of the tooth by a distance 54. As is apparent from the illustrated exemplary embodiment in FIG. 4, if the axial offset 56 is in the range from approximately 30%-40% of the face width 50 of the tooth, then the distance 54 will be in the range from approximately 10%-20% of the face width 50 of the tooth.

The pinion 24 may also include the retract flank 32 of the first face of the tooth tangentially intersecting a first straight line 62 extending substantially parallel to the central axis of the pinion. A point of contact between the retract flank and the first straight line 62 is located at the first center of arc radius 332 of the retract flank 32. The crowd flank 34 of the second face of the tooth may tangentially intersect a second straight line 61 non-parallel to the first straight line 62. A point of contact between the crowd flank 34 and the second straight line 61 may be located at an axial distance 52 from one axial end of the tooth that is approximately 50%±10% of the face width 50 of the tooth. The second straight line 61 defines a lead taper of the crowd flank 34 from the first edge 234 of the crowd flank 34 at the first axial end of the tooth toward the second edge 134 of the crowd flank 34 at the second axial end of the tooth. In the exemplary embodiment of a pinion tooth shown in FIG. 4, the lead taper of the crowd flank 34, results in the thickness of the tooth being greater at the first axial end than at the second axial end. This lead taper along with the axial offset 56 of the center of arc radius 334 of the crowd flank 34 toward the first axial end of the tooth, compensates for a skewing from parallel alignment between the intermeshing teeth of the second reduction pinion 24 and the second reduction gear 25 that may occur as the second reduction gear 25 is deflected during rotation of the crowd drum 5 in a crowd direction. In alternative embodiments, different configurations of the gears and pinions in the crowd gear case, and/or different characteristics of loading and deflection of the gears and pinions during crowding and retracting modes of each dig cycle may be addressed by still further changes to the geometry of the teeth. For example, while the exemplary embodiment of a pinion tooth illustrated in FIG. 4 shows the arc radius 70 for both the crowd flank 34 and the retract flank 32 to be the same, alternative embodiments may include a difference in arc radius of the respective flanks. In some alternative applications, it may be discovered that a larger deflection of the crowd gear case and/or one or more gears and pinions of the crowd gear assembly occurs during the retract mode of each dig cycle rather than during the crowd mode. In such a scenario, another alternative embodiment may include the center of arc radius 334 for the crowd flank 34 being located at approximately the mid-point of the tooth face width 50, with the center of arc radius 332 for the retract flank 32 being offset toward one axial end of the tooth relative to the center of arc radius 334 for the crowd flank. In this alternative embodiment, a lead taper may be provided on the retract flank rather than on the crowd flank. In any case, a tooth for a pinion or gear according to various embodiments of this disclosure compensates for asymmetrical loading and deflections of the gears and/or pinions in a gear assembly by a configuration that provides different geometric profiles for the opposite flanks of the tooth. In the illustrated exemplary embodiment, the axial offset of the center of arc radius 334 for the crowd flank 34 and the lead taper of the crowd flank 34 compensates for a larger amount of deflection of the intermeshing gears and pinions during the crowd mode of a dig cycle.

The first edge 232 of the first face of each tooth on pinion 24 may be spaced by a first crown modification distance 45 in a direction perpendicular to the central axis of the pinion 24 from the first straight line 62. The second edge 132 of the first face may be spaced by a second crown modification distance 45 in a direction perpendicular to the central axis of the pinion from the first straight line 62. In the illustrated exemplary embodiment of this disclosure, the first crown modification distance 45 may be approximately equal to the second crown modification distance 45. The term “approximately equal to”, as used in this disclosure, refers to dimensions that are within standard machining tolerances of each other, and includes dimensions that are within ±10% of each other.

The first edge 234 of the crowd flank 34 may be spaced by the first crown modification distance 45 in a direction perpendicular to the central axis of the pinion 24 from an intersection of the second straight line 61 and a third straight line 60 parallel to the first straight line 62. The second edge 134 of the crowd flank 34 may be spaced from the second straight line 61 by the first crown modification distance 45 and from the third straight line 60 by a total distance equal to a sum of the first crown modification distance 45 and a lead taper distance 47. The lead taper distance 47 may fall within a range from approximately 1.5-5 times the first crown modification distance 45. As a result of the taper modification of the exemplary disclosed embodiment of a tooth for a crowd gear assembly, a first thickness of the tooth at a first axial end of the tooth may be significantly greater than a second thickness of the tooth at the second axial end of the tooth. The first thickness of the tooth at the first axial end of the tooth is defined as the distance between the first edge 232 of the retract flank 32 and the first edge 234 of the crowd flank 34. The second thickness of the tooth at the second axial end of the tooth is defined as the distance between the second edge 132 of the retract flank 32 and the second edge 134 of the crowd flank 34. As shown in FIG. 4, the first thickness of the tooth at the first axial end of the tooth is greater than the second thickness of the tooth at the second axial end of the tooth by an amount equal to the lead taper distance 47. In the exemplary embodiment shown in the figures of this application, the radius 70 of the first circle defining the arc of the retract flank 32 is substantially equal to the radius 70 of the second circle defining the arc of the crowd flank 32, within standard machining tolerances. However, alternative implementations of this disclosure may include the radii of the arcs of the crowd and retract flanks being different, and the resulting offset 56 of the center of arc radius 334 for the crowd flank 34 relative to the center of arc radius 332 for the retract flank 32 may differ from the exemplary disclosed embodiment, in which the offset 56 falls within a range from 30%-40% of the face width 50.

As shown in the exemplary disclosed embodiment of FIG. 4, the first straight line 62 tangentially intersects the retract flank 32 of the first face of each pinion tooth on the second reduction pinion 24 at the first center of arc radius 332 of the retract flank 32. This first straight line 62 extends in a direction substantially parallel to the central axis of the pinion 24. The second straight line 61 tangentially intersects the crowd flank 34 of the second face of each tooth on the second reduction pinion 24 at approximately a midpoint of the face width 50 of the tooth. This second straight line 61 is non-parallel to the first straight line 62, and tapers toward the first straight line 62 at the second axial end of the tooth. As a result, the first thickness of each tooth on the second reduction pinion 24 at the first axial end of each tooth is greater than the second thickness of each tooth at the second axial end of each tooth by an amount equal to the tangent of an angle between the first straight line 62 and the second straight line 61 times the face width 50 of the tooth.

As discussed above, the disclosed embodiments for a pinion tooth geometry that includes a crown modification, offset center of arc radius for the crown, and lead taper on one flank of the pinion tooth compensates for different loading and/or deflection that may be experienced by opposing flanks of the tooth during rotation of the pinion in opposite directions. An exemplary method of manufacturing the teeth on a gear subjected to asymmetric loading will be discussed in the following section.

### INDUSTRIAL APPLICABILITY

The disclosed exemplary embodiments of a tooth geometry for a pinion that includes taper modifications and crown modifications on opposing flanks of the tooth compensate for different loading on the opposing flanks as the pinion is repeatedly rotated first in one direction and then in an opposite direction. In various applications such as the crowd gear assembly for a rope shovel discussed above, a failure to compensate for the different loadings and deflections that intermeshing gears and pinions in a gear assembly may experience under certain working conditions may result in premature failure of the gearing. Forces exerted on the gears and pinions in a crowd gear assembly during crowding of a dipper into a pile of material and retracting of the dipper away from the pile of material may cause the teeth on intermeshing gears and pinions to skew away from parallel alignment, thereby preventing the intermeshing teeth from making full contact across their face width. As less of the face width of the intermeshing teeth comes into contact, the surface area over which the loads are distributed is reduced, and the localization of the forces on a smaller area of each tooth may lead to premature failure of the gears and the gear assembly. Accordingly, the teeth on pinions and/or gears manufactured according to various embodiments of this disclosure may include modifications to the geometries of the opposing flanks of the teeth that compensate for the asymmetric loading and deflections experienced by the gearing during repetitive cycles of loading in opposite directions.

A method of manufacturing a pinion (or gear) according to various implementations of this disclosure may include forming a first (retract) flank 32 on a first face of a tooth of the pinion 24 extending across a face width 50 of the tooth in an axial direction substantially parallel to a central axis of the pinion 24. The first flank 32 extends from a first edge 232 of the first flank 32 at a first axial end of the tooth to a second edge 132 of the first flank 32 at a second axial end of the tooth. The first flank 32 may be provided with a first, convex crown profile shaped as an arc of a first circle with a first radius 70. A first center of arc radius 332 of the first flank 32 is a point on the first flank 32 located on a line perpendicular to the central axis of the pinion 24 and passing through the center of the first circle.

The exemplary disclosed method of manufacturing a pinion (or gear) may further include forming a second (crowd) flank 34 on an opposite and opposing second face of the tooth extending across the face width 50 of the tooth in the axial direction substantially parallel to the central axis of the pinion 24. The second flank 34 extends from a first edge 234 of the second flank 34 at the first axial end of the tooth to a second edge 134 of the second flank 34 at the second axial end of the tooth. The second flank 34 may be provided with a second, convex crown profile shaped as an arc of a second circle with a second radius 70. A second center of arc radius 334 of the second flank 34 is a point on the second flank 34 located on a line perpendicular to the central axis of the pinion 24 and passing through the center of the second circle.

The method of manufacturing the pinion (or gear) may include forming the first (retract) flank 32 such that first center of arc radius 332 of the first flank 32 is located on the first face of the tooth of the pinion at an axial distance 52 from at least one of the first and second axial ends of the tooth that is approximately 50%±10% of the face width 50 of the tooth. The second (crowd) flank 34 may be formed such that the second center of arc radius 334 of the second flank 34 on the second face of the tooth is offset in the axial direction toward one of the first or second axial ends of the tooth relative to the first center of arc radius 332 by a distance 56 that is approximately 30%-40% of the face width 50 of the tooth.

The method of manufacturing the pinion (or gear) according to various disclosed exemplary embodiments may still further include forming the first (retract) flank 32 such that a first straight line 62 tangentially intersecting the first flank 32 of the first face of the tooth at the first center of arc radius 332 of the first flank 32 extends in a direction substantially parallel to the central axis of the pinion 24. The second (crowd) flank 34 may be formed such that a second straight line 61 tangentially intersecting the second flank 34 of the second face of the tooth at approximately a midpoint of the face width 50 of the tooth is non-parallel to the first straight line 62. As a result, a first thickness of the tooth at the first axial end of the tooth is greater than a second thickness of the tooth at a second axial end of the tooth by an amount equal to the tangent of an angle between the first straight line 62 and the second straight line 61 times the face width 50 of the tooth. The amount equal to the tangent of the angle between the first straight line 62 and the second straight line 61 times the face width 50 of the tooth equals the lead taper 47 for the second (crowd) flank 34 relative to the first (retract) flank. As discussed above, the resulting geometries of each of the teeth, each including the disclosed lead taper on one flank and offset center of arc radius for a crown modification on the same flank relative to the opposing flank, compensates for deflection of the intermeshing teeth of the pinions and/or gears out of parallel alignment with each other, and thereby avoids premature failure of the gearing.

It will be apparent to those skilled in the art that various modifications and variations can be made to the disclosed tooth flank geometries and methods of manufacturing a pinion or gear. Other embodiments will be apparent to those skilled in the art from consideration of the specification and practice of the disclosed embodiments of pinion (or gear) tooth geometries and methods of manufacturing pinions and/or gears. It is intended that the specification and examples be considered as exemplary only, with a true scope being indicated by the following claims and their equivalents.

What is claimed is:

1. A tooth of a pinion, the tooth comprising:
a first flank of a first face of the tooth extending across a face width of the tooth in an axial direction substantially parallel to a central axis of the pinion from a first edge of the first face at a first axial end of the tooth to a second edge of the first face at a second axial end of the tooth, the first flank including a first, convex crown profile shaped as an arc of a first circle with a first radius, wherein a first center of arc radius of the first flank is a point on the first flank located on a line perpendicular to the central axis of the pinion and passing through the center of the first circle; and
a second flank of an opposite and opposing second face of the tooth extending across the face width of the tooth in the axial direction from a first edge of the second face at the first axial end of the tooth to a second edge of the second face at a second axial end of the tooth, the second flank including a second, convex crown profile shaped as an arc of a second circle with a second radius, wherein a second center of arc radius of the second flank is a point on the second flank located on a line perpendicular to the central axis of the pinion and passing through the center of the second circle;
wherein the first center of arc radius of the first flank is located on the first face of the tooth at an axial distance from at least one of the first and second axial ends of the tooth that is approximately 50%±10% of the face width of the tooth; and
wherein the second center of arc radius of the second flank on the second face of the tooth is offset in the axial direction toward one of the first or second axial ends of the tooth relative to the first center of arc radius by a distance that is approximately 30-40% of the face width of the tooth.

2. The tooth of claim 1, further including the first flank of the first face of the tooth tangentially intersecting a first straight line extending substantially parallel to the central axis of the pinion, wherein a point of contact between the first flank and the first straight line is located at the first center of arc radius of the first flank.

3. The tooth of claim 2, further including the second flank of the second face of the tooth tangentially intersecting a second straight line non-parallel to the first straight line, wherein a point of contact between the second flank and the second straight line is located at an axial distance from one axial end of the tooth that is approximately 50%±10% of the face width of the tooth.

4. The tooth of claim 3, wherein the first edge of the first face is spaced by a first crown modification distance in a direction perpendicular to the central axis of the pinion from the first straight line, and the second edge of the first face is spaced by a second crown modification distance in a direction perpendicular to the central axis of the pinion from the first straight line, the first crown modification distance being approximately the same as the second crown modification distance.

5. The tooth of claim 4, wherein the first edge of the second face is spaced by the first crown modification distance from an intersection of the second straight line and a third straight line parallel to the first straight line, and wherein the second edge of the second face is spaced from the second straight line by the first crown modification distance and from the third straight line by a total distance equal to a sum of the first crown modification distance and a lead taper distance.

6. The tooth of claim 5, wherein the lead taper distance falls within a range from approximately 1.5-5 times the first crown modification distance.

7. The tooth of claim 6, wherein a first thickness of the tooth at the first axial end of the tooth is the distance between the first edge of the first face and the first edge of the second face, and a second thickness of the tooth at the second axial end of the tooth is the distance between the second edge of the first face and the second edge of the second face, and wherein the second thickness of the tooth at the second axial end of the tooth is less than the first thickness of the tooth at the first axial end of the tooth by an amount equal to the lead taper distance.

8. The tooth of claim 1, wherein the radius of the first circle is equal to the radius of the second circle.

9. The tooth of claim 1, wherein a first straight line tangentially intersecting the first flank of the first face of the tooth at the first center of arc radius of the first flank extends in a direction substantially parallel to the central axis of the pinion, and a second straight line tangentially intersecting the second flank of the second face of the tooth at approximately a midpoint of the face width of the tooth converges closer to the first straight line at the second axial end of the tooth than at the first axial end of the tooth such that a first thickness of the tooth at the first axial end of the tooth is greater than a second thickness of the tooth at the second axial end of the tooth.

10. A pinion for a crowd gear assembly on a rope shovel, wherein the crowd gear assembly is subjected to at least one of asymmetric loading or asymmetric deflection when the pinion is driven in a first crowd direction as compared to when the pinion is driven in an opposite retract direction, the pinion comprising:
a tooth including:
a retract flank on a first face of the tooth extending across a face width of the tooth in an axial direction substantially parallel to a central axis of the pinion from a first edge of the retract flank at a first axial end of the tooth to a second edge of the retract flank at a second axial end of the tooth, the retract flank including a first, convex crown profile shaped as an arc of a first circle with a first radius, wherein a first center of arc radius of the retract flank is a point on the retract flank located on a line perpendicular to the central axis of the pinion and passing through the center of the first circle; and
a crowd flank on an opposite and opposing second face of the tooth extending across the face width of the tooth in the axial direction from a first edge of the crowd flank at the first axial end of the tooth to a second edge of the crowd flank at the second axial end of the tooth, the crowd flank including a second, convex crown profile shaped as an arc of a second circle with a second radius, wherein a second center of arc radius of the crowd flank is a point on the crowd flank located on a line perpendicular to the central axis of the pinion and passing through the center of the second circle;
wherein the first center of arc radius of the retract flank is located on the first face of the tooth at an axial distance from at least one of the first and second axial ends of the tooth that is approximately 50%±10% of the face width of the tooth; and
wherein the second center of arc radius of the crowd flank on the second face of the tooth is offset in the axial direction toward one of the first or second axial ends of the tooth relative to the first center of arc radius by a distance that is approximately 30-40% of the face width of the tooth.

11. The pinion of claim 10, further including the retract flank of the first face of the tooth tangentially intersecting a first straight line extending substantially parallel to the central axis of the pinion, wherein a point of contact between the retract flank and the first straight line is located at the first center of arc radius of the retract flank.

12. The pinion of claim 11, further including the crowd flank of the second face of the tooth tangentially intersecting a second straight line non-parallel to the first straight line, wherein a point of contact between the crowd flank and the second straight line is located at an axial distance from one axial end of the tooth that is approximately 50%±10% of the face width of the tooth.

13. The pinion of claim 12, wherein the first edge of the first face is spaced by a first crown modification distance in a direction perpendicular to the central axis of the pinion from the first straight line, and the second edge of the first face is spaced by a second crown modification distance in a direction perpendicular to the central axis of the pinion from the first straight line, the first crown modification distance being approximately the same as the second crown modification distance.

14. The pinion of claim 13, wherein the first edge of the crowd flank is spaced by the first crown modification distance from an intersection of the second straight line and a third straight line parallel to the first straight line, and wherein the second edge of the crowd flank is spaced from the second straight line by the first crown modification distance and from the third straight line by a total distance equal to a sum of the first crown modification distance and a lead taper distance.

15. The pinion of claim 14, wherein the lead taper distance falls within a range from approximately 1.5-5 times the first crown modification distance.

16. The pinion of claim 15, wherein a first thickness of the tooth at a first axial end of the tooth is the distance between the first edge of the retract flank and the first edge of the crowd flank, and a second thickness of the tooth at a second axial end of the tooth is the distance between the second edge of the retract flank and the second edge of the crowd flank, and wherein the second thickness of the tooth at the second axial end of the tooth is less than the first thickness of the tooth at the first axial end of the tooth by an amount equal to the lead taper distance.

17. The pinion of claim 10, wherein the radius of the first circle is equal to the radius of the second circle.

18. The pinion of claim 10, wherein:
a first straight line tangentially intersecting the retract flank of the first face of the tooth at the first center of arc radius of the retract flank extends in a direction substantially parallel to the central axis of the pinion;
a second straight line tangentially intersecting the crowd flank of the second face of the tooth at approximately a midpoint of the face width of the tooth is non-parallel to the first straight line; and
a first thickness of the tooth at the first axial end of the tooth is greater than a second thickness of the tooth at a second axial end of the tooth by an amount equal to the tangent of an angle between the first straight line and the second straight line times the face width of the tooth.

19. A method of manufacturing a gear, comprising:
forming a first flank on a first face of a tooth of the gear extending across a face width of the tooth in an axial direction substantially parallel to a central axis of the gear from a first edge of the first flank at a first axial end of the tooth to a second edge of the first flank at a second axial end of the tooth, the first flank including a first, convex crown profile shaped as an arc of a first circle with a first radius, wherein a first center of arc radius of the first flank is a point on the first flank located on a line perpendicular to the central axis of the gear and passing through the center of the first circle; and
forming a second flank on an opposite and opposing second face of the tooth extending across the face width of the tooth in the axial direction from a first edge of the second flank at the first axial end of the tooth to a second edge of the second flank at the second axial end of the tooth, the second flank including a second, convex crown profile shaped as an arc of a second circle with a second radius, wherein a second center of arc radius of the second flank is a point on the second flank located on a line perpendicular to the central axis of the gear and passing through the center of the second circle;
wherein the first center of arc radius of the first flank is located on the first face of the tooth at an axial distance from at least one of the first and second axial ends of the tooth that is approximately 50%±10% of the face width of the tooth; and
wherein the second center of arc radius of the second flank on the second face of the tooth is offset in the axial direction toward one of the first or second axial ends of the tooth relative to the first center of arc radius by a distance that is approximately 30-40% of the face width of the tooth.

20. The method of claim 19, further including:
forming the first flank such that a first straight line tangentially intersecting the first flank of the first face of the tooth at the first center of arc radius of the first flank extends in a direction substantially parallel to the central axis of the gear; and
forming the second flank such that a second straight line tangentially intersecting the second flank of the second face of the tooth at approximately a midpoint of the face width of the tooth is non-parallel to the first straight line; wherein
a first thickness of the tooth at the first axial end of the tooth is greater than a second thickness of the tooth at a second axial end of the tooth by an amount equal to the tangent of an angle between the first straight line and the second straight line times the face width of the tooth.
